(19) United States
(12) Patent Application Publication
(10) Pub. No.: US 2019/0357503 A1
(43) Pub. Date: Nov. 28, 2019

(54) AQUACULTURE SYSTEM

(71) Applicant: TAIWAN WATER RECYCLE TECHNOLOGY CO., LTD., Taichung City (TW)

(72) Inventor: Chi-Tse Kuo, Taichung City (TW)

(21) Appl. No.: 15/990,642

(22) Filed: May 27, 2018

(51) Int. Cl. A01K 63/04; C02F 9/00; B04C 5/12; B04C 5/04; B04C 9/00

(52) U.S. Cl. CPC A01K 63/045; A01K 63/047; A01K 63/042; C02F 1/44; B04C 5/12; B04C 5/04; B04C 9/00; C02F 9/00

(57) ABSTRACT

An aquaculture system contains: a cultivation tank, a vortex separator, a drawing pump, multiple bubble separators, multiple filtering units, an aeration unit, and a collection tank. The cultivation tank includes multiple first plates, multiple second plates, an open accommodation chamber, and a conduit tube. The vortex separator includes an inlet and an outlet. The drawing pump is connected beside the vortex separator and the outlet. Each bubble separator includes a cylindrical container and a micro bubble generating unit. Each filtering unit includes a filtration room, multiple filtering membrane sets, at least one water pipe, multiple dish-shaped bags, and multiple vacuum pumps. The aeration unit includes multiple air supply pipes, and the collection tank is employed to receive residual baits and excrements of little fishes or shrimps and particulate matters from the second discharge orifice of each bubble separator and the filtration room.

### FIELD OF THE INVENTION

The present invention relates to aquaculture equipment, and more particularly to an aquaculture system which provide brilliant quality of recycled water so as to enhance survival rate of aquatic animals.

### BACKGROUND OF THE INVENTION

Super-intensive aquaculture system is a closed connection system of a cultivation pool and a water treatment system so as to purify and feed water back to the cultivation pool, thus recycling the water.

Liquid bubble separator of circulating water system is disclosed in U.S. Pat. No. 9,451,759, and the circulating water system contains a filtering unit and a bubble separator connected on a peripheral side of the filtering unit so that when aquaculture water id not filtered, colloidal mucus and suspended particles in the water are eliminated by bubbles so as to avoid obstruction of filtration membranes of the filtering unit.

However, the circulating water system has following defects:

1. The residual baits and excrements of little fishes or shrimps and suspended solids (SS) block in an inlet of the bubble separator or the micro bubble generating unit, and the bubble separator cannot separate bubbles from the water.

2. The water is pumped to the bubble separator so as to push colloidal mucus, residual baits, excrements, and suspended particles upward and to discharge out of a cylinder of the bubble separator. But some solid impurities gather on a bottom of the cylinder, so the bubble separator cannot be cleaned easily.

3. Sludge deposits on a bottom of the cultivation tank, and heavy deposition (colloidal substances, celluloses, residual baits, and excrements) of solid wastes filtered by the filtering unit cannot be discharged completely, thus having poor water circulation.

The present invention has arisen to mitigate and/or obviate the afore-described disadvantages.

### SUMMARY OF THE INVENTION

The primary aspect of the present invention is to provide an aquaculture system which contains a vortex separator arranged among the cultivation tank and the multiple bubble separators so as to separate deposited substances and to avoid obstruction in nozzles of the multiple bubble separators.

Further aspect of the present invention is to provide an aquaculture system which contains the second discharge orifice defined on the bottom of each bubble separator so as to discharge deposited substances on the bottom of each bubble separator, thus cleaning each bubble separator easily.

Another aspect of the present invention is to provide an aquaculture system which contains the third discharge orifice formed on the first sheet and a second tilted face extending from a peripheral side of the first sheet so that the deposited substances are pushed to the third discharge orifice by using the second tilted face automatically, thus cleaning the deposited substances quickly.

To obtain above-mentioned aspects, an aquaculture system provided by the present invention comprises: a cultivation tank, a vortex separator, a drawing pump, multiple bubble separators, multiple filtering units, an aeration unit, and a collection tank.

The cultivation tank is configured to accommodate aquaculture water and includes multiple first plates, multiple second plates, an open accommodation chamber formed by the multiple first plates and the multiple second plates, and a conduit tube, wherein each of the multiple first plates has an opening and a first tilted face extending to the opening from a peripheral side of each first plate.

The vortex separator is arranged beside a peripheral side of the cultivation tank, and the vortex separator includes an inlet and an outlet, wherein the inlet is connected with the conduit tube of the cultivation tank so as to conduct overflow water pumped from the conduit tube, and solid particles and liquid impurities of the overflow water are separated by way of centrifugal gravity.

The drawing pump is connected beside the vortex separator and the outlet so as to pump the overflow water via the vortex separator.

Each of the multiple bubble separators includes a cylindrical container and a micro bubble generating unit housed in the cylindrical container, wherein the cylindrical container includes an inflow pipe connected with the outlet segment of the drawing pump, an outflow pipe, at least one guide orifice configured to conduit air from an external environment, a first discharge orifice, and a second discharge orifice defined on a center of a bottom of the cylindrical container.

Each of the multiple filtering units includes a filtration room connected with the opening of the cultivation tank, and each filtering unit includes multiple filtering membrane sets fixed on the filtration room, at least one water pipe, multiple dish-shaped bags tightly inserted on the at least one water pipe, and multiple vacuum pumps corresponding to each of the at least one water pipe.

The aeration unit includes multiple air supply pipes arranged outside the open accommodation chamber of the cultivation tank so that after air sprays to swirl colloidal substances, solid substances and sludge in the cultivation tank, the colloidal substances, the solid substances, and the sludge are pushed to the opening of the cultivation tank by using the second tilted face of the first sheet.

The collection tank is employed to receive residual baits and excrements of little fishes or shrimps and particulate matters from the second discharge orifice of each bubble separator and the filtration room.

### BRIEF DESCRIPTION OF THE DRAWINGS

FIG. 1 is a schematic view of an aquaculture system according to a preferred embodiment of the present invention.

FIG. 2 is a side plan view showing the assembly of the aquaculture system according to the preferred embodiment of the present invention.

FIG. 3 is a perspective view showing the assembly of a cultivation tank of the aquaculture system according to the preferred embodiment of the present invention.

FIG. 4 is a cross sectional view showing the assembly of a vortex separator according to the preferred embodiment of the present invention.

FIG. 5 is another cross sectional view showing the assembly of the vortex separator according to the preferred embodiment of the present invention.

FIG. 6 is another side plan view showing the assembly of the aquaculture system according to the preferred embodiment of the present invention.

FIG. 7 is a top plan view showing the assembly of a part of the aquaculture system according to the preferred embodiment of the present invention.

FIG. 8 is a cross sectional view showing the assembly of a part of the aquaculture system according to the preferred embodiment of the present invention.

### DETAILED DESCRIPTION OF THE PREFERRED EMBODIMENTS

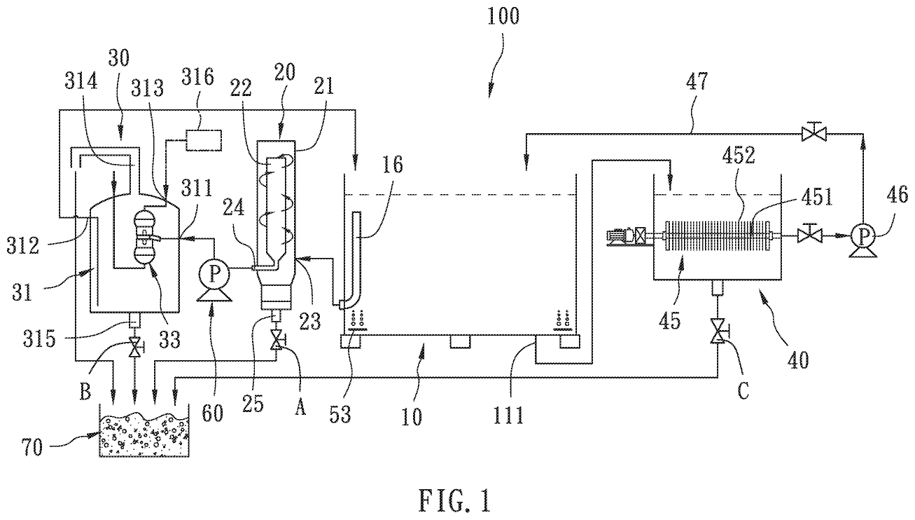

With reference to FIGS. 1-3, an aquaculture system 100 according to a preferred embodiment of the present invention comprises: a cultivation tank 10, a vortex separator 20, multiple bubble separators 30, multiple filtering units 40, an aeration unit 50, a drawing pump 60, and a collection tank 70.

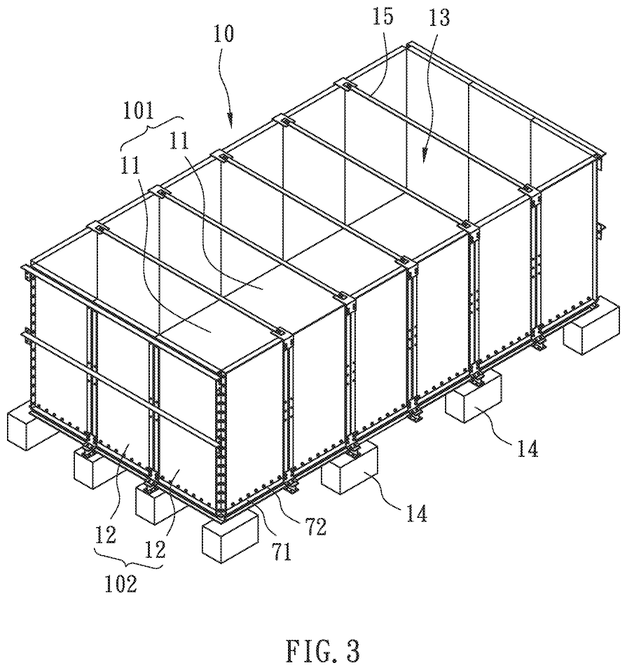

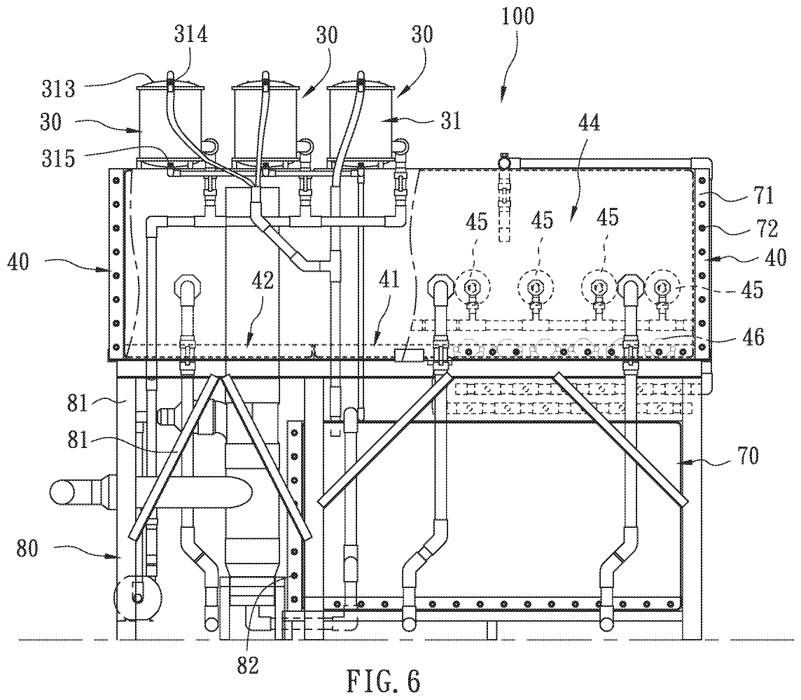

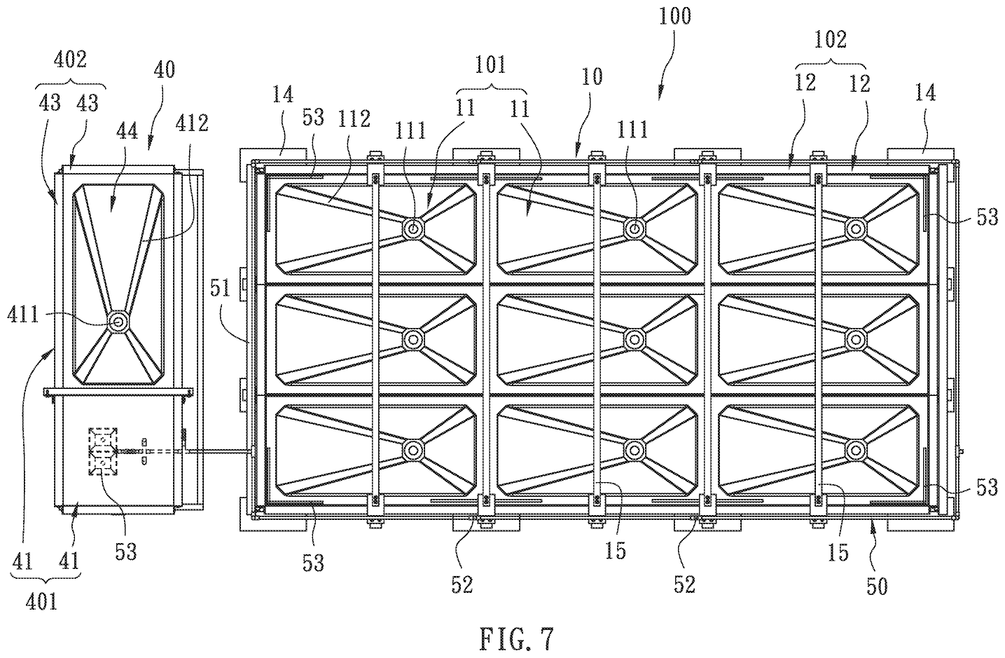

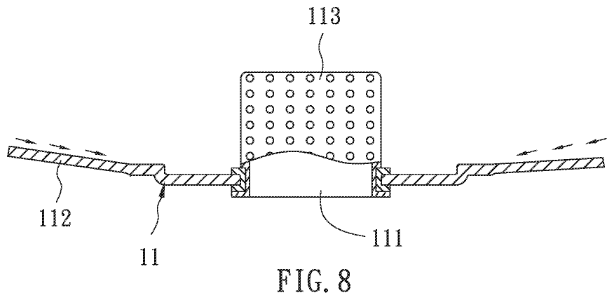

Referring to FIGS. 3 and 6, the cultivation tank 10 includes multiple first plates 11, multiple second plates 12, an open accommodation chamber 13 formed by the multiple first plates 11 and the multiple second plates 12, multiple pedestals 14, and a conduit tube 16 vertically connected in the open accommodation chamber 13. As shown in FIG. 7, each of the multiple first plates 11 has an opening 111 and a first tilted face 112 extending to the opening 111 from a peripheral side of each first plate 11 so that colloidal substances, celluloses, residual baits, and excrements gather to the opening 111 from a bottom of each first plate 11. Each first plate 11 further has a mesh pipe 113 connected on the opening 111 (as illustrated in FIG. 8) and having multiple pores so as to stop little fishes or shrimps swinging out of the opening 111. Each first plate 11 of the cultivation tank 10 is mounted on a top of each of the multiple pedestals 14. Each first plate 11 has a bottom fence 101 on which the multiple second plates 12 are connected so as to form multiple peripheral fences 102, and the bottom fence 101 and the multiple peripheral fences 102 define a rectangular groove. The cultivation tank 10 further includes multiple ribs 15 separately fixed on a top of any two adjacent peripheral fences 102 so as to reinforce the cultivation tank 10 and to erect any one of an automatic sprinkler system, a water quality monitoring system, and a remote monitor equipment (not shown) on the multiple ribs 15.

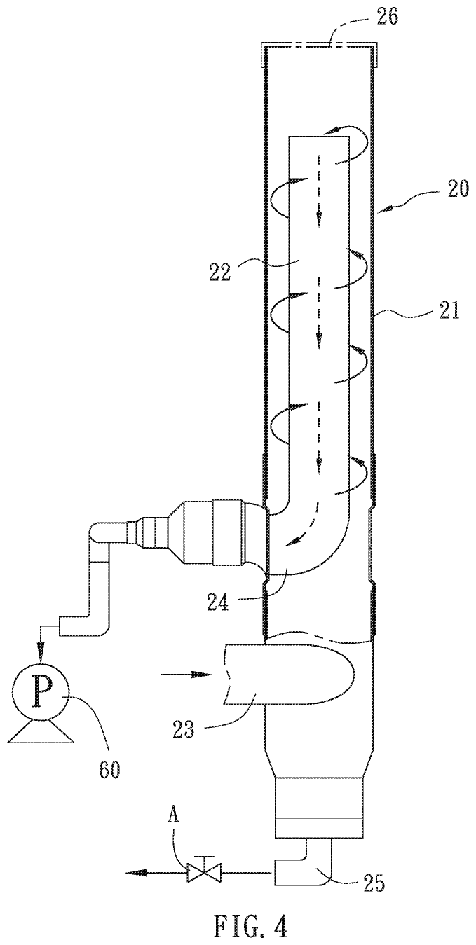

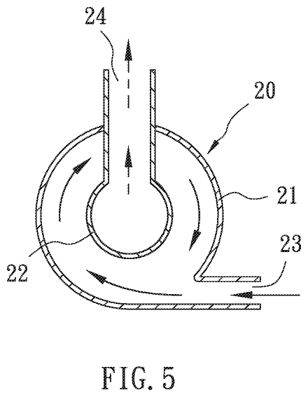

As shown in FIGS. 1 and 4, the vortex separator 20 is arranged beside a peripheral side of the cultivation tank 10, and the vortex separator 20 includes a first cylinder 21 and a second cylinder 22 accommodated in the first cylinder 21, wherein a height of the second cylinder 22 is lower than the first cylinder 21. The vortex separator 20 further includes an inlet 23 defined around a tangential direction of an outer wall of the first cylinder 21, an outlet 24 formed on a bottom of the second cylinder 22, and an aperture 25 arranged on a bottom of the first cylinder 21. As shown in FIG. 5, the inlet 23 is located on a lower end of the outer wall of the first cylinder 21, and the outlet 24 is away from and opposite to the inlet 23. After water is pumped into the first cylinder 21 from the cultivation tank 10 via the inlet 23, the water flows around the second cylinder 22 so as to swirl centrifugally and quickly (as presented by solid arrows of FIGS. 4 and 5). In the meantime, the colloidal substances, the celluloses, the residual baits, and the excrements sink to the aperture 25 and are discharged to the collection tank 70 by way of a first control valve A. Thereafter, the water flows into the second cylinder 22 from a top of the second cylinder 22 (as indicated by dotted arrows) and is guided to flow out of the outlet 24. The vortex separator 20 further includes a filtration mesh 26 covered on a top of the first cylinder 21 so as to avoid object(s) dropping into the vortex separator 20.

With reference to FIGS. 1 and 6, each of the multiple bubble separators 30 includes a cylindrical container 31 and a micro bubble generating unit 33 housed in the cylindrical container 31, wherein the cylindrical container 31 includes an inflow pipe 311 connected with an outlet segment of the drawing pump 60, an outflow pipe 312, at least one guide orifice 313 configured to conduit air from an external environment, a first discharge orifice 314, and a second discharge orifice 315 defined on a center of a bottom of the cylindrical container 31. The colloidal substances, the celluloses, the residual baits, and the excrements are discharged into the collection tank 70 from the bottom of the cylindrical container 31 by way of the second discharge orifice 315 and a second control valve B on a bottom of each bubble separator 30. In this embodiment, three bubble separators 30 are parallelly connected above the cultivation tank 10. Each of the at least one guide orifice 313 of each bubble separator 30 is in connection with an ozone generating unit 316 so as to feed ozone (O³) into the open accommodation chamber 13, thus obtaining sterilization.

Referring to FIGS. 1, 6, and 7, each of the multiple filtering units 40 is located above the collection tank 70 and has a same height as the cultivation tank 10, each filtering unit 40 includes a first sheet 41, a second sheet 42, multiple surround sheets 43, a filtration room 44 connected with the opening 111 of the cultivation tank 10, and multiple filtering membrane sets 45 fixed on the filtration room 44, wherein the first sheet 41 and the second sheet 42 define a foundation 401, the multiple surround sheets 43 surround the first sheet 41 and the second sheet 42 so as to define a surrounding fringe 402, the first sheet 41 has a third discharge orifice 411 and a second tilted face 412 extending to the opening 111 from a peripheral side of the first sheet 41 (the structure of the first sheet 41 is the same as each first plate 11). Each of the multiple filtering membrane sets 45 is in a circular plate shape and has at least one water pipe 451, multiple dish-shaped bags 452 tightly inserted on the at least one water pipe 451, and multiple vacuum pumps 46 corresponding to each of the at least one water pipe 451 so that the multiple filtering membrane sets 45 separate liquids and solids of foul water of the opening 111 by using a vacuum suction force of the multiple vacuum pumps 46. Each filtering unit 40 further includes an outlet pipe 47 connected with each water pipe 451 so that filtrate is fed back to the cultivation tank 10 via the outlet pipe 47, thus producing recycled water. Furthermore, wastewater is discharged to the collection tank 70 by way of a third control valve C, thus filtering aquaculture water continuously.

After the recycled water flows back to the cultivation tank 10 from the multiple bubble separators 30 and the multiple filtering units 40, a water level of the open accommodation chamber 13 of the cultivation tank 10 is higher than a water level of the filtration room 44 of each filtering unit 40, a level difference between the open accommodation chamber 13 and the filtration room 44 produces so that the foul water is automatically fed into the filtration room 44 from the bottom of the cultivation tank 10 so as to separate the liquids and the solids of the foul water.

As shown in FIG. 7, the aeration unit 50 includes multiple air supply pipes 51 arranged outside the cultivation tank 10, multiple air adjustment valves 52 respectively connected among the multiple air supply pipes 51, multiple aeration tubes 53 individually communicating with the multiple air supply pipes 51 and accommodated in the cultivation tank 10, and a blower 54 connected with the multiple air supply pipes 51 so as to conduit the air into the multiple air supply pipes 51 from an external environment, and a volume of the air is controlled by the multiple air adjustment valves 52, then the air is fed into the cultivation tank 10 via the multiple aeration tubes 53, thus supplying dissolved oxygen to the water of the cultivation tank 10. In this embodiment, the multiple aeration tubes 53 are arranged around the peripheral side of the cultivation tank 10 so that after the air sprays to swirl the colloidal substances, solid substances and sludge in the cultivation tank 10, the colloidal substances, the solid substances, and the sludge are pushed to the opening 111 by using the first tilted face 112 of the first plate 11 (as shown in FIG. 8), thus avoiding deposition of the sludge.

The collection tank 70 is employed to receive large or heavy particles of the residual baits and excrements of the little fishes or shrimps and particulate matters from the aperture 25 of the vortex separator 20, the second discharge orifice 315 of each bubble separator 30, and the third discharge orifice 411 of the filtration room 44.

As illustrated in FIG. 6, the aquaculture system 100 further comprises a support unit 80 including multiple angle irons 81 and multiple screw bolts 82. The multiple filtering units 40 are supported on the peripheral side of the cultivation tank 10 by the multiple angle irons 81, and the collection tank 70 is locked below the multiple filtering units 40 by using the multiple angle irons 81. As shown in FIG. 1, the multiple first plates 11 and the multiple second plates 12 of the cultivation tank 10 are connected by way of the multiple angle irons 81 and the multiple screw bolts 82. Also, first sheets 41, second sheets 42, and the multiple surround sheets 43 of the multiple filtering units 40 are connected by using the multiple angle irons 81 and the multiple screw bolts 82 which are all match with multiple washers (not shown) respectively.

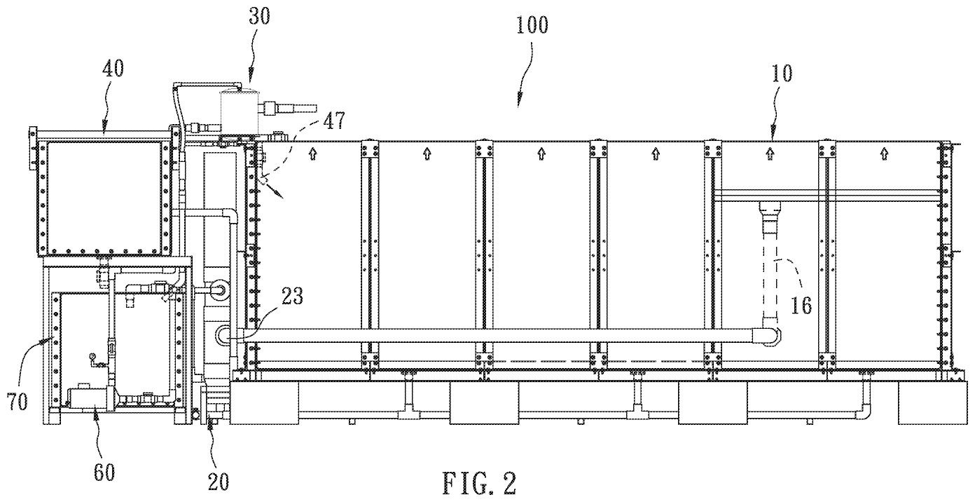

With reference to FIGS. 1 and 2, in a circulation process of aquaculture water, the aquaculture water at a high level overflows into the inlet 23 of the vortex separator 20. Referring further to FIGS. 4 and 5, the water flows around the second cylinder 22 centrifugally and quickly, in the meantime, the colloidal substances, the celluloses, the residual baits, and the excrements of the water sink into the aperture 25 and are conducted into the collection tank 70, then light substances of the water overflow into the second cylinder 22 from the top of the second cylinder 22 and are pumped into each bubble separator 30 by the drawing pump 60 of the outlet 24, thereafter overflow water flows through the micro bubble generating unit 33 to mix with the air and to separate micro bubbles from the overflow water, hence the colloidal substances, the celluloses, ammonia nitrogen, the residual baits and the excrements float with the micro bubbles. Thereafter, the colloidal substances, the celluloses, the ammonia nitrogen, the residual baits and the excrements are discharged into the collection tank 70, and the water flows back to the cultivation tank 10 via the outflow pipe 312. As shown in FIGS. 1 and 6, the residual baits and the excrements deposited on the bottom of the cylindrical container 31 are discharged into the collection tank 70 via the second discharge orifice 315.

In a filtering path of another circulation process, as illustrated in FIGS. 1 and 6, the colloidal substances, the celluloses, the residual baits, the excrements, and the sludge deposited on the bottom of the cultivation tank 10 are discharged into the filtration room 44 of each filtering unit 40 via the opening 111 of each first plate 11, such that that the multiple filtering membrane sets 45 separate the liquids and the solids of the foul water of the opening 111 so as to eliminate colloidal mucus in the aquaculture water, and filtered water produces from each water pipe 451 and is conducted into the cultivation tank 10, wherein the residual baits and the excrements of the little fishes or shrimps are stopped in the filtration room 44 of each filtering unit 40 and are discharged into the collection tank 70, thus circulating the aquaculture water successively.

Therefore, the aquaculture system 100 has advantages as follows:

1. Before separating overflow water from the micro bubbles, solid particles and liquid impurities are separated by the vortex separator 20, and the overflow water is by centrifugal gravity of the first cylinder 21 and the second cylinder 22 of the vortex separator 20 so that the colloidal substances, the celluloses, the residual baits, and the excrements sinks, thus avoiding obstruction in the inlet 23 of the vortex separator 20 or in nozzles of the micro bubble generating unit.

2. The second control valve B is turned on by way of the second discharge orifice 315 of each bubble separator 30 so as to discharge deposited substances (such as the colloidal substances, the celluloses, the residual baits, and the excrements) on the bottom of each bubble separator 30, thus enhancing separation of protein vacuoles.

3. The deposited substances are discharged out of the third discharge orifice 411 of the filtration room 44 of each filtering unit 40, and the deposited substances are pushed to the third discharge orifice 411 by using the second tilted face 412 and the third control valve C, thus cleaning the deposited substances.

4. After the recycled water flows into the cultivation tank 10 from each bubble separator 30 and each filtering unit 40, the water level of the open accommodation chamber 13 of the cultivation tank 10 is higher than the water level of the filtration room 44 of each filtering unit 40 so as to form the level difference between the open accommodation chamber 13 and the filtration room 44, hence the foul water is automatically fed into the filtration room 44 from the bottom of the cultivation tank 10 so as to save power source.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An aquaculture system comprising:
a cultivation tank configured to accommodate aquaculture water and including multiple first plates, multiple second plates, an open accommodation chamber formed by the multiple first plates and the multiple second plates, and a conduit tube, wherein each of the multiple first plates has an opening and a first tilted face extending to the opening from a peripheral side of each first plate;
a vortex separator arranged beside a peripheral side of the cultivation tank, and the vortex separator including an inlet and an outlet, wherein the inlet is connected with the conduit tube of the cultivation tank so as to conduct overflow water pumped from the conduit tube, and solid particles and liquid impurities of the overflow water are separated by way of centrifugal gravity;
a drawing pump connected beside the vortex separator and the outlet so as to pump the overflow water via the vortex separator;
multiple bubble separators, each of the multiple bubble separators including a cylindrical container and a micro bubble generating unit housed in the cylindrical container, wherein the cylindrical container includes an inflow pipe connected with the outlet segment of the drawing pump, an outflow pipe, at least one guide orifice configured to conduit air from an external environment, a first discharge orifice, and a second discharge orifice defined on a center of a bottom of the cylindrical container;
multiple filtering units, each of the multiple filtering units including a filtration room connected with the opening of the cultivation tank, and each filtering unit including multiple filtering membrane sets fixed on the filtration room, at least one water pipe, multiple dish-shaped bags tightly inserted on the at least one water pipe, and multiple vacuum pumps corresponding to each of the at least one water pipe;
an aeration unit including multiple aeration tubes arranged around the open accommodation chamber of the cultivation tank so that after air sprays to swirl colloidal substances, solid substances and sludge in the cultivation tank, the colloidal substances, the solid substances, and the sludge are pushed to the opening by using the first tilted face of the first plate;
a collection tank employed to receive residual baits and excrements of little fishes or shrimps and particulate matters from the second discharge orifice of each bubble separator and the filtration room.

2. The aquaculture system as claimed in claim 1 further comprising multiple pedestals, wherein each first plate of the cultivation tank is mounted on a top of each of the multiple pedestals.

3. The aquaculture system as claimed in claim 1, wherein each first plate of the cultivation tank has a bottom fence on which the multiple second plates are connected so as to form multiple peripheral fences, and the bottom fence and the multiple peripheral fences define a rectangular groove, wherein the cultivation tank further includes multiple ribs separately fixed on a top of any two adjacent peripheral fences.

4. The aquaculture system as claimed in claim 1, wherein the vortex separator includes a first cylinder and a second cylinder accommodated in the first cylinder, and a height of the second cylinder is lower than the first cylinder, wherein the vortex separator further includes the inlet defined around a tangential direction of an outer wall of the first cylinder, the outlet formed on a bottom of the second cylinder, and an aperture arranged on a bottom of the first cylinder, wherein the inlet is located on a lower end of the outer wall of the first cylinder, the outlet is away from and opposite to the inlet, and the aperture of the vortex separator connects to the collection tank.

5. The aquaculture system as claimed in claim 1, wherein multiples bubble separator are parallelly connected above the cultivation tank and the multiple filtering units.

6. The aquaculture system as claimed in claim 1, wherein each filtering unit includes a first sheet, a second sheet, and multiple surround sheets, wherein the first sheet and the second sheet define a foundation, and the multiple surround sheets surround the first sheet and the second sheet so as to define the filtration room, wherein the first sheet has a third discharge orifice and a second tilted face extending to the third discharge orifice from a peripheral side of the first sheet.

7. The aquaculture system as claimed in claim 1, wherein multiple filtering membrane sets of each filtering unit are equidistantly fixed on the filtration room, and each filtering unit further includes an outlet pipe connected with each water pipe so that the overflow water is fed to the cultivation tank via the outlet pipe.

8. The aquaculture system as claimed in claim 1 further comprising a support unit which includes multiple angle irons and multiple screw bolts, the multiple filtering units are supported on the peripheral side of the cultivation tank by the multiple angle irons, and the collection tank is locked below the multiple filtering units by using the multiple angle irons.

9. The aquaculture system as claimed in claim 1, wherein the aeration unit includes multiple air supply pipes arranged outside the cultivation tank, multiple air adjustment valves respectively connected among the multiple air supply pipes, and a blower connected with the multiple air supply pipes.

10. The aquaculture system as claimed in claim 4, wherein the vortex separator further includes a filtration mesh covered on a top of the first cylinder.
